(19) United States
(12) Patent Application Publication
(10) Pub. No.: US 2017/0114714 A1
(43) Pub. Date: Apr. 27, 2017

(54) COMPRESSOR HOUSING FOR A TURBOCHARGER AND METHOD FOR MANUFACTURING THE SAME

(71) Applicants: OTICS Corporation, Nishio-city (JP); TOYOTA JIDOSHA KABUSHIKI KAISHA, Toyota-shi (JP)

(72) Inventors: Tetsuya NIWA, Nishio-shi (JP); Masahide SAKURAI, Nishio-shi (JP); Tomoyuki ISOGAI, Nishio-shi (JP); Osamu MAEDA, Toyota-shi (JP); Koichi YONEZAWA, Toyota-shi (JP)

(73) Assignees: OTICS Corporation, Nishio-city (JP); TOYOTA JIDOSHA KABUSHIKI KAISHA, Toyota-shi (JP)

(21) Appl. No.: 15/276,004

(22) Filed: Sep. 26, 2016

(30) Foreign Application Priority Data
Oct. 27, 2015 (JP) 2015-211261

(51) Int. Cl. F02B 37/02; F04D 29/62; F04D 29/28; F04D 29/08; F04D 17/10; F04D 29/42

(52) U.S. Cl. CPC F02B 37/025; F04D 17/10; F04D 29/4206; F04D 29/284; F04D 29/08; F04D 29/624

(57) ABSTRACT

A compressor housing for a turbocharger and a method for manufacturing the same. The method includes steps of preparing a scroll piece having an intake port forming portion forming an intake port, an intake-side wall surface of a scroll chamber, and a scroll outer peripheral portion covering an outer peripheral side of the scroll chamber; preparing a shroud piece having a cylindrical shroud press-fit portion to be press fitted into the intake port forming portion, an inner circumferential wall surface of the scroll chamber, and a recessed portion formed on a wall surface covering an outer peripheral side of an impeller; forming an abradable seal having a shroud surface by injection molding of resin into the recessed portion; and press fitting the shroud press-fit portion into the intake port forming portion.

### CROSS-REFERENCE TO RELATED APPLICATION

The present application claims priority under 35 U.S.C. §119 to Japanese Application No. 2015-211261, filed on Oct. 27, 2015, entitled “COMPRESSOR HOUSING FOR A TURBOCHARGER AND METHOD FOR MANUFACTURING THE SAME”. The contents of this application are incorporated herein by reference in their entirety.

### BACKGROUND OF THE INVENTION

Field of the Invention

The present invention relates to a compressor housing for a turbocharger and a method for manufacturing the same.

Description of the Related Art

In compressors used in a supercharger such as a turbocharger of an automobile, compression efficiency can be improved by reducing a tip clearance between the impeller and the shroud surface opposed to the impeller. The reduction of the tip clearance, however, might cause a blade of the impeller to contact the shroud surface of the compressor housing due to vibrations, deflection of the impeller rotating shaft, or other reasons. This might damage the impeller.

There is a compressor housing known in the art that has a resin abradable seal arranged at the portion forming the shroud surface. In such a structure, even in the event of contact between a blade of the impeller and the shroud surface, only the abradable seal forming the shroud surface is cut while the tip clearance between the impeller and the shroud surface is kept small and the impeller will not be damaged.

### PATENT LITERATURE

[Patent Literature 1] JP-A-2014-70628

The abradable seal can be attached to the compressor housing, for example, by injecting resin material as a material for forming the abradable seal directly into the compressor housing. In this case, a holding base for securing the compressor housing during injection is needed. Since the holding base needs to hold the compressor housing entirely, the size of the holding base needs to be large, which results in increase of the cost of the mold with difficulty to acquire high precisions of the mold and at accuracy.

As one of other methods for attaching the abradable seal to the compressor housing, JP-A-2014-70628 discloses a ring with an abradable seal, which is formed by attaching an abradable seal to a ring-shaped metal member. The ring with an abradable seal is press fitted into the compressor housing. In the method disclosed in JP-A-2014-70628, however, the compressor housing has an undercut at a portion to be formed into the scroll chamber, and thus is formed by gravity casting, for example. As a result, the method reduces productivity and increases manufacturing costs. It is thinkable for improving productivity and reducing manufacturing costs to form a separate piece that is separated from a portion of the scroll chamber from the compressor housing so that the pieces each have no undercuts. Such a compressor housing however needs the ring with an abradable seal and the separate piece in addition to a compressor housing body, resulting in increase in number of components and complicated assembling work. This tends to reduce productivity and increase manufacturing costs in the end.

The present invention has been made under such a background to provide a compressor housing for a turbocharger that is manufactured at high productivity and can reduce manufacturing costs, and a method for manufacturing the compressor housing.

### SUMMARY OF THE INVENTION

One aspect of the present invention provides a method for manufacturing a compressor housing for a turbocharger, the compressor housing being able to house an impeller having a plurality of blades and including an intake port for sucking in air toward the impeller, a scroll chamber into which air discharged from the impeller is introduced, and a shroud surface opposed to the impeller, the method including:

a step of preparing a scroll piece having an intake port forming portion that forms the intake port, an intake-side wall surface of the scroll chamber, and a scroll outer peripheral portion covering an outer peripheral side of the scroll chamber;

a step of preparing a shroud piece having a cylindrical shroud press-fit portion configured to be press fitted into the intake port forming portion, an inner circumferential wall surface of the scroll chamber, and a recessed portion formed on a wall surface covering an outer peripheral side of the impeller;

a step of forming an abradable seal having the shroud surface by injection molding of resin into the recessed portion; and

a step of press fitting the shroud press-fit portion into the intake port forming portion.

Another aspect of the present invention provides a compressor housing for a turbocharger, the compressor housing being able to house an impeller having a plurality of blades and including an intake port for sucking in air toward the impeller, a scroll chamber into which air discharged from the impeller is introduced, and a shroud surface opposed to the impeller, the compressor housing including:

a scroll piece having an intake port forming portion that forms the intake port, an intake-side wall surface of the scroll chamber, and a scroll outer peripheral portion covering an outer peripheral side of the scroll chamber;

a shroud piece having a cylindrical shroud press-fit portion formed to be press fitted into the intake port forming portion, an inner circumferential wall surface of the scroll chamber, and a recessed portion formed on a wall surface covering an outer peripheral side of the impeller; and

an abradable seal having the shroud surface, the abradable seal being formed by injection molding of resin into the recessed portion.

In the method for manufacturing the compressor housing for a turbocharger described above, the compressor housing includes the scroll piece and the shroud piece that are formed separately from each other, and the abradable seal is formed on the shroud piece which is independent from the scroll piece. Accordingly, a holding base that is needed for injection molding of resin as a material of the abradable seal, may have a size sufficient to secure the shroud piece. Consequently, the holding base can be made smaller compared with one used for securing the compressor housing entirely, which is larger than the shroud piece, like in conventional methods. As a result, the cost of the holding base can be reduced, and precision of the mold and attaching accuracy are easily increased.

In addition, the intake-side wall surface of the scroll chamber is formed by the scroll piece, and the inner circumferential wall surface of the scroll chamber is formed by the shroud piece, so that the scroll piece can be shaped to have no undercut. Accordingly, the scroll piece and the shroud piece can be formed by die casting to improve productivity and reduce manufacturing costs. Moreover, the abradable seal is formed by injection molding into the recessed portion of the shroud piece, so that the abradable seal and the shroud piece are formed integrally. This reduces the number of components for attaching the abradable seal to reduce the assembling work, thereby improving productivity and reducing manufacturing costs.

The above compressor housing for a turbocharger has the same operation and effect as a compressor housing for a turbocharger manufactured by the above manufacturing method.

As described above, according to the present invention, it is possible to provide a compressor housing for a turbocharger that is manufactured at high productivity with reduced manufacturing costs, and a method for manufacturing the compressor housing.

### BRIEF DESCRIPTION OF THE DRAWINGS

FIG. 1 is a cross-sectional view of a compressor housing in a first embodiment, illustrating the overall structure of the compressor housing;

FIG. 2 is a cross-sectional view of a shroud piece in the first embodiment;

FIG. 3 is a schematic illustration for describing a step in the first embodiment of forming an abradable seal;

FIG. 4 is a schematic illustration for describing a step in the first embodiment of press fitting a shroud press-fit portion into an intake port forming portion; and

FIG. 5 is a schematic illustration for describing a step in the first embodiment of press fitting an outer peripheral annular press-fit portion into a scroll outer peripheral portion.

### DESCRIPTION OF THE PREFERRED EMBODIMENTS

The abradable seal forms the shroud surface that is opposed to the impeller. The abradable seal allows a tip clearance between blades of the impeller and the shroud surface to be kept as small as possible.

For example, if the blades of the impeller contact the shroud surface due to vibrations, deflection of an impeller rotating shaft, or other reasons, the abradable seal that forms the shroud surface is cut. Then the tip clearance between the blades of the impeller and the shroud surface is still kept small.

As described above, since the abradable seal is required to be cut when the blades of the impeller contact the shroud surface, resins such as a nylon (R), a polyester, or a polyimide may be employed as a material for the abradable seal.

In the method for manufacturing the compressor housing for a turbocharger, the scroll piece and the shroud piece are preferably made of the same metal material. In this case, thermal expansion coefficients of the scroll piece and the shroud piece match with each other. Thus, the scroll piece and the shroud piece maintain the appropriate engagement therebetween even under operational environment for the turbocharger where temperature changes drastically, thereby improving durability of the compressor housing. That is, it is prevented, for example, that the engaging force between the scroll piece and the shroud piece is reduced or excessive stress is applied between the pieces with the drastic temperature changes.

In the method for manufacturing the compressor housing for a turbocharger, it is preferable that the recessed portion includes a plurality of grooves including a groove recessed in a radial direction of the shroud piece and a groove recessed in an axial direction perpendicular to the radial direction, and in the step of forming the abradable seal, the abradable seal is engaged with the shroud piece by filling the grooves with the resin to form a part of the abradable seal. In this case, the grooves ensure a larger contact area between the abradable seal formed by the resin filled into the grooves and wall surface of the shroud piece. Further, the grooves are shaped to be recessed in the radial and axial directions. As a result, the abradable seal is caught in the grooves to be prevented from dropping off in the radially inward and axial directions.

The method for manufacturing the compressor housing for a turbocharger preferably includes a step of press fitting an outer peripheral annular piece having an outer circumferential wall surface of the scroll chamber into the scroll outer peripheral portion, after the step of press fitting the shroud press-fit portion into the intake port forming portion. In this case, the method eliminates a need for machining a back plate to form the outer circumferential wall surface of the scroll chamber. This improves the productivity.

In the compressor housing for a turbocharger, the scroll piece and the shroud piece are preferably made of the same metal material. In this case, thermal expansion coefficients of the scroll piece and the shroud piece match with each other. Thus, the scroll piece and the shroud piece maintain the appropriate engagement therebetween even under operational environment for the turbocharger where temperature changes drastically, thereby improving durability of the compressor housing. That is, it is prevented, for example, that excessive stress is applied between the scroll piece and the shroud piece with the drastic temperature changes.

In the compressor housing for a turbocharger, it is preferable that the recessed portion includes a plurality of grooves including a groove recessed in a radial direction of the shroud piece and a groove recessed in an axial direction perpendicular to the radial direction, and the abradable seal be engaged with the shroud piece, with part of the abradable seal extending into the grooves. In this case, the grooves ensure a larger contact area between the abradable seal formed by the resin filled into the grooves and wall surface of the shroud piece. Further, the grooves are shaped to be recessed in the radial and axial directions. As a result, the abradable seal is caught in the grooves to be prevented from dropping off in the radially inward and axial directions.

The compressor housing for a turbocharger preferably has an outer peripheral annular piece having an outer peripheral annular press-fit portion press fitted inside the scroll outer peripheral portion and an outer circumferential wall surface of the scroll chamber. In this case, there is no need for machining a back plate to form the outer circumferential wall surface of the scroll chamber. In this way, a compressor housing for a turbocharger that is manufactured at high productivity can be provided.

### EMBODIMENT

### Embodiment 1

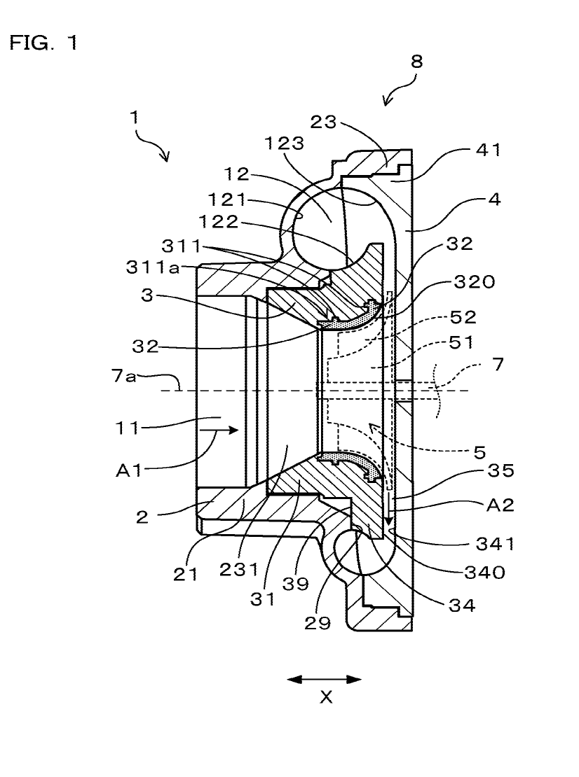

An embodiment of the compressor housing for a turbocharger and the method for manufacturing the compressor housing for a turbocharger will be described with reference to FIGS. 1 to 5.

A compressor housing 1 for a turbocharger of the embodiment can house an impeller 5 having a plurality of blades 52 and includes an intake port 11 for sucking in air A1 toward the impeller 5, a scroll chamber 12 into which air discharged from the impeller 5 is introduced, and a shroud surface 320 opposed to the impeller 5.

The compressor housing 1 for a turbocharger includes a scroll piece 2, a shroud piece 3, and an abradable seal 32.

The scroll piece 2 has an intake port forming portion 21 that forms the intake port 11, an intake-side wall surface 121 of the scroll chamber 12, and a scroll outer peripheral portion 23 covering an outer peripheral side of the scroll chamber 12.

The shroud piece 3 has a cylindrical shroud press-fit portion 31 formed to be press fitted inside the intake port forming portion 21, an inner circumferential wall surface 122 of the scroll chamber 12, and a recessed portion 311 formed on a wall surface 311a formed to cover an outer peripheral side of the impeller 5.

The abradable seal 32 is formed by filling the recessed portion 311 with resin by injection molding and has a shroud surface 320.

Hereinafter, the compressor housing 1 for a turbocharger and the method for manufacturing the compressor housing 1 will be described in detail.

As shown in FIG. 1, the compressor housing 1 of the embodiment forms an outer shell of a compressor 8 used in a turbocharger of an automobile. The compressor housing 1 can house the impeller 5 having the plurality of blades 52 and includes the intake port 11 for sucking in air A1 toward the impeller 5 and the scroll chamber 12 into which air A2 discharged from the impeller 5 is introduced. The impeller 5 is fixed at one end of a rotor shaft 7 rotatably supported in a bearing mechanism (not shown). The rotor shaft 7 axially rotates about a central axis 7a, and the impeller 5 rotates with the rotation of the rotor shaft 7. A direction in which the central axis 7a extends is an axial direction X.

As shown in FIG. 1, the scroll piece 2, which forms a part of the compressor housing 1 is made of metal. The scroll piece 2 has the intake port forming portion 21, the intake-side wall surface 121 of the scroll chamber 12, and the scroll outer peripheral portion 23, as described above. The intake port forming portion 21 has at a bottom portion a contact portion 29 that abuts against the shroud piece 3 in the axial direction.

As shown in FIG. 1, the shroud piece 3, which forms a part of the compressor housing 1 has the shroud press-fit portion 31, the inner circumferential wall surface 122 of the scroll chamber 12, and the recessed portion 311 formed on the wall surface 311a, as described above. The shroud piece 3 further has a diffuser surface forming portion 34 that forms a diffuser surface 340 extending from the wall surface 311a toward the scroll chamber 12.

As shown in FIG. 1, the shroud press-fit portion 31 has an intake passage 231 communicating with the intake port 11. A positioning portion 39 for positioning the shroud piece 3 in the axial direction is formed at a connecting portion between the shroud press-fit portion 31 and the diffuser surface forming portion 34. The positioning portion 39 abuts against the contact portion 29 of the scroll piece 2 in the axial direction.

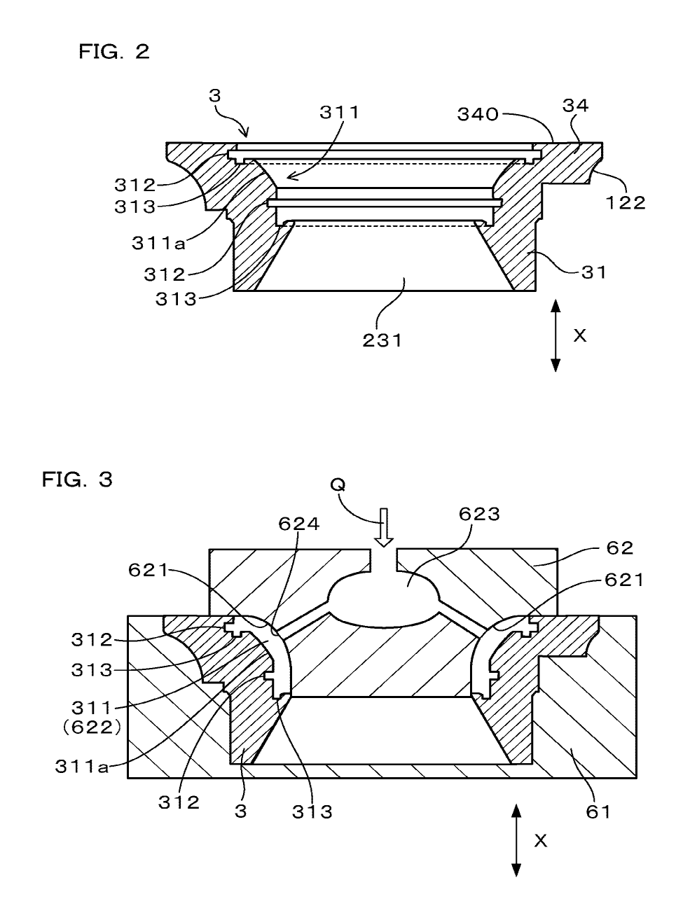

In the embodiment, as shown in FIG. 2, the recessed portion 311 includes a plurality grooves including a groove 312 recessed in a radial direction of the shroud piece 3 and a groove 313 recessed in the axial direction X perpendicular to the radial direction. Here, the radial direction of the shroud piece 3 includes all directions that extend from the central axis 7a perpendicularly to the axial direction X, as shown in FIG. 1.

As shown in FIG. 1, the recessed portion 311 is provided with the abradable seal 32 formed by filling the recessed portion 311 with resin by injection molding. The shroud piece 3 engages with the abradable seal 32 with part of the abradable seal 32 extending into the plurality of grooves 312 and 313 (refer to FIG. 2). In the embodiment, a polyimide resin is used as the resin for forming the abradable seal 32.

The compressor housing 1 of the embodiment further includes an outer peripheral annular piece 4 as shown in FIG. 1. The outer peripheral annular piece 4 includes an outer peripheral annular press-fit portion 41 press fitted inside the scroll outer peripheral portion 23 of the scroll piece 2 and an outer circumferential wall surface 123 of the scroll chamber 12. The outer peripheral annular piece 4 has a diffuser opposing surface 341 at a position opposed to the diffuser surface 340 of the shroud piece 3. The diffuser opposing surface 341 is away from the diffuser surface 340 by a predetermined distance and parallel with the diffuser surface 340. A diffuser passage 35 is formed between the diffuser surface 340 and the diffuser opposing surface 341, and the air A2 discharged from the impeller 5 is pressurized through at the diffuser passage 35. A back plate may be provided that is formed integrally with a bearing housing (not shown), instead of the outer peripheral annular piece 4.

As shown in FIG. 1, the impeller 5 is arranged on an inner side of the shroud piece 3. The impeller 5 is formed such that the circumferentially arranged blades 52 are projected from an outer circumferential surface of a hub 51. The blades 52 are arranged opposed to the shroud surface 320 of the abradable seal 32.

According to the compressor 8, as the impeller 5 rotates with the axial rotation of the rotor shaft 7, the air A1 is sucked in from the intake port 11 through the intake passage 231 into the impeller 5. The sucked air is accelerated by the blades 52 of the impeller 5, and then sent into the scroll chamber 12 through the diffuser passage 35 while being pressurized within the diffuser passage 35, as shown by a reference character A2.

Next, a description will be given of the method for manufacturing the compressor housing 1 of the embodiment.

The method for manufacturing the compressor housing 1 of the embodiment is a method for manufacturing the compressor housing 1 for a turbocharger, which can house the impeller 5 having the plurality of blades 52 and includes the intake port 11 for sucking air toward the impeller 5, the scroll chamber 12 into which air discharged from the impeller 5 is introduced, and the shroud surface 320 opposed to the impeller 5. The method includes a step of preparing the scroll piece 2 (first step S1), a step of preparing the shroud piece 3 (second step S2), a step of forming the abradable seal 32 (third step S3), and a step of press fitting the shroud press-fit portion 31 into the intake port forming portion 21 (fourth step S4).

In the first step S1, the scroll piece 2 including the intake port forming portion 21 that forms the intake port 11, the intake-side wall surface 121 of the scroll chamber 12, and the scroll outer peripheral portion 23 covering the outer peripheral side of the scroll chamber 12, is prepared.

In the second step S2, the shroud piece 3 including the cylindrical shroud press-fit portion 31 to be press fitted into the intake port forming portion 21, the inner circumferential wall surface 122 of the scroll chamber 12, and the recessed portion 311 formed on the wall surface 311a to cover the outer peripheral side of the impeller 5, is prepared.

In the third step S3, the abradable seal 32 that includes the shroud surface 320 is formed by injection molding of resin into the recessed portion 311.

In the fourth step S4, the shroud press-fit portion 31 is press fitted into the intake port forming portion 21.

Hereinafter, these steps will be described in detail.

In the first step S1, the scroll piece 2 is formed by die casting. In the second step S2, the shroud piece 3 is also formed by die casting. The order of the first and second steps S1 and S2 is not limited and the first step S1 may be performed after the second step S2.

Next, in the third step S3, the shroud piece 3 is placed inside a holding base 61 first, as shown in FIG. 3. The holding base 61 is formed along the outer circumferential wall surface of the shroud piece 3 except the inner circumferential wall surface of the shroud piece 3. Then, an injection mold 62 is placed on a side of the shroud piece 3 opposite to the shroud press-fit portion 31. The injection mold 62 has a shroud molding surface 621 that conforms to the shroud surface 320. Thus, a space 622 is formed between the shroud molding surface 621 and the wall surface 311a that forms the recessed portion 311.

As shown in FIG. 3, the injection mold 62 includes a resin supply passage 623 through which resin is supplied and has an injection port 624 communicating with the resin supply passage 623, at the shroud molding surface 621. Resin that has been supplied through the resin supply passage 623 is injected through the injection port 624 into the space 622 as shown by an arrow Q. Thus, the resin is charged in the space 622 (recessed portion 311) and the resin is spread throughout the grooves 312 and 313 formed at the recessed portion 311, thereby providing the abradable seal 32 having the shroud surface 320, at the recessed portion 311.

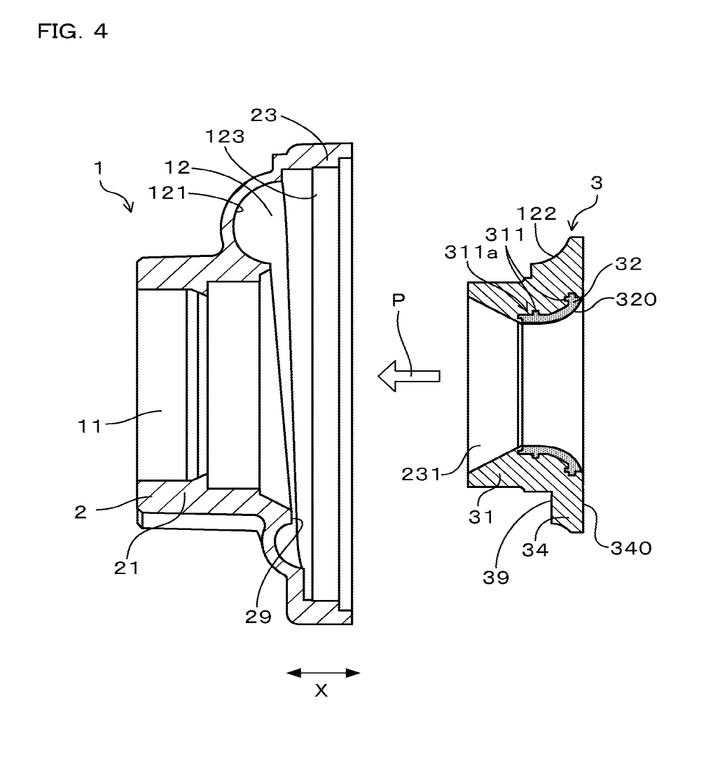

Next, in the fourth step S4, the shroud press-fit portion 31 is press fitted into the intake port forming portion 21 in the axial direction X, as shown by an arrow P in FIG. 4. Then, as shown in the same figure, the positioning portion 39 formed at the shroud piece 3 is brought into abutment with the contact portion 29 formed at the scroll piece 2 in the axial direction X. Thus, the shroud piece 3 is positioned in the axial direction X.

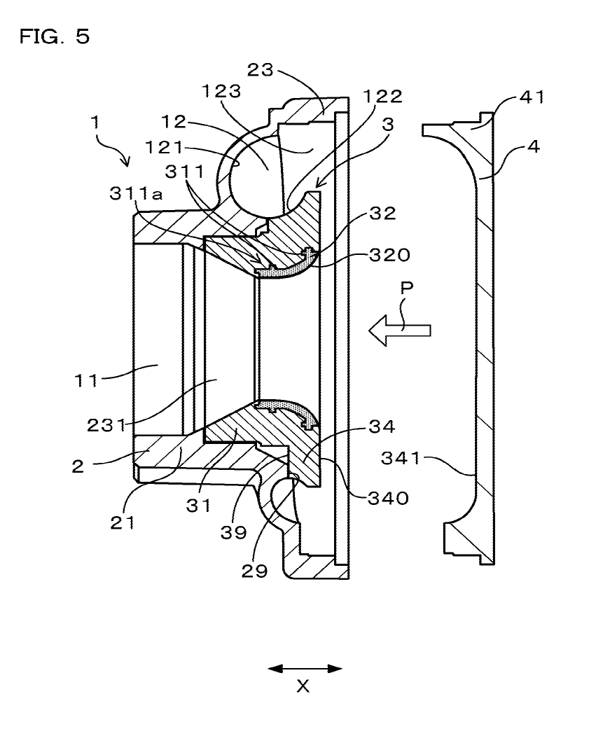

Next, in the embodiment, the outer peripheral annular press-fit portion 41 of the outer peripheral annular piece 4 is press fitted into the scroll outer peripheral portion 23 of the scroll piece 2 in the axial direction X, as shown by an arrow P in FIG. 5. Thus, the scroll chamber 12 is formed by the intake-side wall surface 121, the inner circumferential wall surface 122, and the outer circumferential wall surface 123 of the scroll chamber 12.

These steps provide the compressor housing 1 shown in FIG. 1.

Next, a description will be given of the operation and effect of the compressor housing 1 for a turbocharger and the method for manufacturing the compressor housing 1 of the embodiment. According to the method for manufacturing the compressor housing 1 for a turbocharger of the embodiment, the compressor housing 1 includes the scroll piece 2 and the shroud piece 3 that are formed separately from each other, and the abradable seal 32 is formed on shroud piece 3 which is independent from the scroll piece 2. Accordingly, the holding base 61 needed for injection molding of resin as a material of the abradable seal 32, may have a size sufficient to secure the shroud piece 3.

Consequently, the holding base 61 can be made smaller compared with one used for securing the compressor housing entirely, which is larger than the shroud piece 3, like in conventional methods. As a result, the cost of the holding base 61 can be reduced, and precision of the mold and attaching accuracy are easily increased.

In addition, the intake-side wall surface 121 of the scroll chamber 12 is formed by the scroll piece 2, and the inner circumferential wall surface 122 of the scroll chamber 12 is formed by the shroud piece 3, so that the scroll piece 2 can be shaped to have no undercut. Accordingly, the scroll piece 2 and the shroud piece 3 can be formed by die casting to improve productivity and reduce manufacturing costs. Moreover, the abradable seal 32 is formed by injection molding into the recessed portion 311 of the shroud piece 3, so that the abradable seal 32 and the shroud piece 3 are formed integrally. This reduces the number of components for attaching the abradable seal 32 to reduce the assembling work, thereby improving productivity and reducing manufacturing costs.

In the embodiment, the scroll piece 2 and the shroud piece 3 are made of the same metal material. Accordingly, the thermal expansion coefficients of the scroll piece 2 and the shroud piece 3 match with each other. Thus, the scroll piece 2 and the shroud piece 3 maintain the appropriate engagement therebetween even under operational environment for the turbocharger where temperature changes drastically, thereby improving durability of the compressor housing 1. That is, it is prevented, for example, that the mating force between the scroll piece 2 and the shroud piece 3 is reduced or excessive stress is applied between the pieces with the drastic temperature changes.

In the embodiment, the recessed portion 311 includes a plurality of grooves including the groove 312 recessed in the radial direction of the shroud piece 3 and the groove 313 recessed in the axial direction perpendicular to the radial direction. In the step of forming the abradable seal 32 (third step S3), the abradable seal 32 is engaged with the shroud piece 2 by filling the grooves 312 and 313 with the resin to form a part of the abradable seal 32. In this way, the grooves 312 and 313 ensure a larger contact area between the abradable seal 32 formed by the resin filled into the grooves 312 and 313 and the wall surface 311a of the shroud piece 3. Further, the grooves 312 and 313 are shaped to be recessed in the radial and axial directions. As a result, the abradable seal 32 is caught in the grooves 312 and 313 to be prevented from dropping off in the radially inward and axial directions.

The number of the plurality of grooves 312 and 313 to be provided at the recessed portion 311 is not particularly limited. In the embodiment, two radial grooves 312 and two axial grooves 313 are provided, while the embodiment works as long as at least one radial groove 312 and at least one axial groove 313 are provided. The shape of each of the grooves 312 and 312 is not particularly limited, either, and cross-sectional shapes of the grooves 312 and 313 in the axial direction X may be a triangle or a semicircle, for example, in addition to a rectangle as in the embodiment. Also, the arrangement of the grooves 312 and 312 in the recessed portion 311 is not particularly limited, either, and many grooves 312 and 313 may be formed throughout the recessed portion 311. In addition, the grooves 312 and 313 are each formed in the recessed portion 311 along the entire radial length of the recessed portion 311 (that is, in an annular shape) in the embodiment, while the present invention is not limited to this and the grooves 312 and 313 may each be formed along only a part of the radial length. In this case, part of the abradable seal 32 is charged in the grooves formed along only the part of the radial length to provide an effect of detent that prevents the abradable seal 32 from rotating about the central axis 7a.

Moreover, the embodiment includes the step of press fitting the outer peripheral annular piece 4 having the outer circumferential wall surface 123 of the scroll chamber 12 into the scroll outer peripheral portion 23 after the step of press fitting the shroud press-fit portion 31 into the intake port forming portion 21. This eliminates the need for machining a back plate to form the outer circumferential wall surface 123 of the scroll chamber 12, thereby improving productivity.

The compressor housing 1 for a turbocharger of the embodiment is provided with the abradable seal 32 formed by filling the recessed portion 311 with resin. This improves productivity and can reduce manufacturing costs, as described above.

According to the compressor housing 1 for a turbocharger of the embodiment, the scroll piece 2 and the shroud piece 3 are made of the same metal material. Accordingly, thermal expansion coefficients of the scroll piece 2 and the shroud piece 3 match with each other. Thus, the scroll piece 2 and the shroud piece 3 maintain the appropriate engagement therebetween even under operational environment for the turbocharger where temperature changes drastically, thereby improving durability of the compressor housing 1. That is, it is prevented, for example, that excessive stress is applied between the scroll piece 2 and the shroud piece 3 with the drastic temperature changes.

In the compressor housing 1 for a turbocharger, the recessed portion 311 includes the plurality of grooves 312 and 313 including the groove 312 recessed in the radial direction of the shroud piece 3 and the groove 313 recessed in the axial direction X perpendicular to the radial direction, and the shroud piece 3 engages with the abradable seal 32 with part of the abradable seal 32 extending into the plurality of grooves 312 and 313. Thus, the grooves 312 and 313 ensure a larger contact area between the abradable seal 32 formed by the resin filled into the grooves 312 and 313 and the wall surface 311a of the shroud piece 3. Further, the grooves 312 and 313 are shaped to be recessed in the radial and axial directions, so that the abradable seal 32 is caught in the grooves 312 and 313 to be prevented from dropping off in the radially inward and axial directions.

According to the present embodiment, there can be provided the compressor housing 1 for a turbocharger, which is manufactured at high productivity and can reduce manufacturing costs.

1. A method for manufacturing a compressor housing for a turbocharger, the compressor housing being able to house an impeller having a plurality of blades and including an intake port for sucking in air toward the impeller, a scroll chamber into which air discharged from the impeller is introduced, and a shroud surface opposed to the impeller, the method comprising:
a step of preparing a scroll piece having an intake port forming portion that forms the intake port, an intake-side wall surface of the scroll chamber, and a scroll outer peripheral portion covering an outer peripheral side of the scroll chamber;
a step of preparing a shroud piece having a cylindrical shroud press-fit portion configured to be press fitted into the intake port forming portion, an inner circumferential wall surface of the scroll chamber, and a recessed portion formed on a wall surface covering an outer peripheral side of the impeller;
a step of forming an abradable seal having the shroud surface by injection molding of resin into the recessed portion; and
a step of press fitting the shroud press-fit portion into the intake port forming portion.

2. The method for manufacturing a compressor housing for a turbocharger according to claim 1, wherein
the scroll piece and the shroud piece are made of same metal material.

3. The method for manufacturing a compressor housing for a turbocharger according to claim 1, wherein
the recessed portion includes a plurality of grooves including a groove recessed in a radial direction of the shroud piece and a groove recessed in an axial direction perpendicular to the radial direction, and
in the step of forming the abradable seal, the abradable seal is engaged with the shroud piece by filling the grooves with the resin to form a part of the abradable seal.

4. The method for manufacturing a compressor housing for a turbocharger according to claim 2, wherein
the recessed portion includes a plurality of grooves including a groove recessed in a radial direction of the shroud piece and a groove recessed in an axial direction perpendicular to the radial direction, and
in the step of forming the abradable seal, the abradable seal is engaged with the shroud piece by filling the grooves with the resin to form a part of the abradable seal.

5. The method for manufacturing a compressor housing for a turbocharger according to claim 1, further comprising
a step of press fitting an outer peripheral annular piece having an outer circumferential wall surface of the scroll chamber into the scroll outer peripheral portion, after the step of press fitting the shroud press-fit portion into the intake port forming portion.

6. The method for manufacturing a compressor housing for a turbocharger according to claim 2, further comprising
a step of press fitting an outer peripheral annular piece having an outer circumferential wall surface of the scroll chamber into the scroll outer peripheral portion, after the step of press fitting the shroud press-fit portion into the intake port forming portion.

7. The method for manufacturing a compressor housing for a turbocharger according to claim 3, further comprising
a step of press fitting an outer peripheral annular piece having an outer circumferential wall surface of the scroll chamber into the scroll outer peripheral portion, after the step of press fitting the shroud press-fit portion into the intake port forming portion.

8. The method for manufacturing a compressor housing for a turbocharger according to claim 4, further comprising
a step of press fitting an outer peripheral annular piece having an outer circumferential wall surface of the scroll chamber into the scroll outer peripheral portion, after the step of press fitting the shroud press-fit portion into the intake port forming portion.

9. A compressor housing for a turbocharger, the compressor housing being able to house an impeller having a plurality of blades and including an intake port for sucking in air toward the impeller, a scroll chamber into which air discharged from the impeller is introduced, and a shroud surface opposed to the impeller, the compressor housing comprising:
a scroll piece having an intake port forming portion that forms the intake port, an intake-side wall surface of the scroll chamber, and a scroll outer peripheral portion covering an outer peripheral side of the scroll chamber;
a shroud piece having a cylindrical shroud press-fit portion formed to be press fitted into the intake port forming portion, an inner circumferential wall surface of the scroll chamber, and a recessed portion formed on a wall surface covering an outer peripheral side of the impeller; and
an abradable seal having the shroud surface, the abradable seal being formed by injection molding of resin into the recessed portion.

10. The compressor housing for a turbocharger according to claim 9, wherein
the scroll piece and the shroud piece are made of same metal material.

11. The compressor housing for a turbocharger according to claim 9, wherein
the recessed portion includes a plurality of grooves including a groove recessed in a radial direction of the shroud piece and a groove recessed in an axial direction perpendicular to the radial direction,
the shroud piece engages with the abradable seal, with part of the abradable seal extending into the grooves.

12. The compressor housing for a turbocharger according to claim 10, wherein
the recessed portion includes a plurality of grooves including a groove recessed in a radial direction of the shroud piece and a groove recessed in an axial direction perpendicular to the radial direction,
the shroud piece engages with the abradable seal, with part of the abradable seal extending into the grooves.

13. The compressor housing for a turbocharger according to claim 9, further comprising
an outer peripheral annular piece having an outer peripheral annular press-fit portion press fitted inside the scroll outer peripheral portion and an outer circumferential wall surface of the scroll chamber.

14. The compressor housing for a turbocharger according to claim 10, further comprising
an outer peripheral annular piece having an outer peripheral annular press-fit portion press fitted inside the scroll outer peripheral portion and an outer circumferential wall surface of the scroll chamber.

15. The compressor housing for a turbocharger according to claim 11, further comprising
an outer peripheral annular piece having an outer peripheral annular press-fit portion press fitted inside the scroll outer peripheral portion and an outer circumferential wall surface of the scroll chamber.

16. The compressor housing for a turbocharger according to claim 12, further comprising
an outer peripheral annular piece having an outer peripheral annular press-fit portion press fitted inside the scroll outer peripheral portion and an outer circumferential wall surface of the scroll chamber.
